(19) United States
(12) Patent Application Publication
(10) Pub. No.: US 2010/0188343 A1
(43) Pub. Date: Jul. 29, 2010

(54) VEHICULAR CONTROL SYSTEM COMPRISING TOUCH PAD AND VEHICLES AND METHODS

(76) Inventor: Edward William Bach, Galloway, OH (US)

Correspondence Address: ULMER & BERNE, LLP;ATTN: DIANE BELL, 600 VINE STREET, SUITE 2800, CINCINNATI, OH, 45202, US

(21) Appl. No.: 12/361,667

(22) Filed: Jan. 29, 2009

(51) Int. Cl. G06F 3/041; G06F 19/00

(52) U.S. Cl. 345/173; 701/36

(57) ABSTRACT

A vehicular control system is provided and includes a steering control interface, a touch pad, and an actuator. The touch pad is coupled with the steering control interface and is configured to receive an input from an operator. The actuator is coupled with the steering control interface and is configured to facilitate selection by an operator from among a plurality of vehicular functions. Vehicles and methods are also provided.

### TECHNICAL FIELD

Vehicles are provided which include a touch pad coupled with a steering control interface, such as a steering wheel.

### BACKGROUND

Conventional vehicles are often provided with a variety of interactive devices such as a radio, a cruise control system, and a climate control system. These devices each include controls (e.g., knobs, pushbuttons) that facilitate selective adjustment of the devices by an operator. Conventional vehicles are also provided with a navigation system. The navigation system is typically provided with a touch-responsive display such that the navigational system can be controlled by an operator. The interactive devices and the navigation system are disposed within the passenger compartment in proximity to the operator, but often require an operator to remove their hands from a steering wheel of the vehicle to facilitate their operation.

### SUMMARY

In accordance with one embodiment, a vehicular control system comprises a steering control interface, an actuator, a first touch pad, a navigation system, and a second touch pad. The actuator is coupled with the steering control interface and is configured to facilitate selection from among a plurality of vehicular functions. The first touch pad is coupled with the steering control interface and is configured to receive a first input from an operator. The first touch pad is further configured to facilitate control of a selected one of the vehicular functions according to the first input. The second touch pad is coupled with the steering control interface and is configured to receive a second input from an operator. The second touch pad is further configured to facilitate control of the navigation system according to the second input.

In accordance with another embodiment, a vehicular control system comprises a steering control interface, an actuator, a touch pad, and an electronic control unit. The actuator is coupled with the steering control interface and is configured to facilitate selection by an operator from among a plurality of vehicular functions. The actuator is further configured to generate a first signal. The touch pad is coupled with the steering control interface and is configured to receive an input from an operator. The touch pad is further configured to generate a second signal based upon the input. The electronic control unit is in electrical communication with each of the actuator and the touch pad. The electronic control unit is configured to operate in either a first mode or a second mode. When the electronic control unit is in the first mode, the electronic control unit is configured such that a first one of the plurality of vehicular functions is controlled by the second signal. When the electronic control unit is in the second mode, the electronic control unit is configured such that a second one of the plurality of vehicular functions is controlled by the second signal. Upon generation of the first signal, the electronic control unit is configured to switch operation from the first mode to the second mode and to maintain operation in the second mode for a predetermined amount of time, after which predetermined amount of time the electronic control unit is configured to automatically switch operation back to the first mode.

In accordance with yet another embodiment, a method of sequentially controlling respective vehicular functions through use of a touch pad comprises receiving an operator input from a touch pad coupled with a steering control interface. The method further comprises facilitating control of a first vehicular function from among a plurality of vehicular functions according to the operator input. The method still further comprises selecting a second vehicular function from among the plurality of vehicular functions and, for a predetermined amount of time following the selecting of the second vehicular function, facilitating control of the second vehicular function according to the operator input. The method yet further comprises automatically resuming facilitating control of the first vehicular function according to the operator input, upon completion of the predetermined amount of time.

### BRIEF DESCRIPTION OF THE DRAWINGS

Various embodiments will become better understood with regard to the following description, appended claims and accompanying drawings wherein:

FIG. 1 is a perspective view of a vehicle which incorporates a vehicular control system according to one embodiment;

FIG. 2 is an enlarged elevational view depicting a steering wheel and associated components of the vehicle of FIG. 1;

FIG. 3 is an enlarged view depicting a first portion, identified with dashed lines, of the steering wheel and associated components shown in FIG. 2;

FIG. 4 is an enlarged view depicting a second portion, identified with dashed lines, of the steering wheel and associated components shown in FIG. 2;

FIG. 5 is a schematic view depicting a navigation system according to one embodiment; and

FIG. 6 is a schematic view depicting a vehicular control system according to one embodiment.

### DETAILED DESCRIPTION

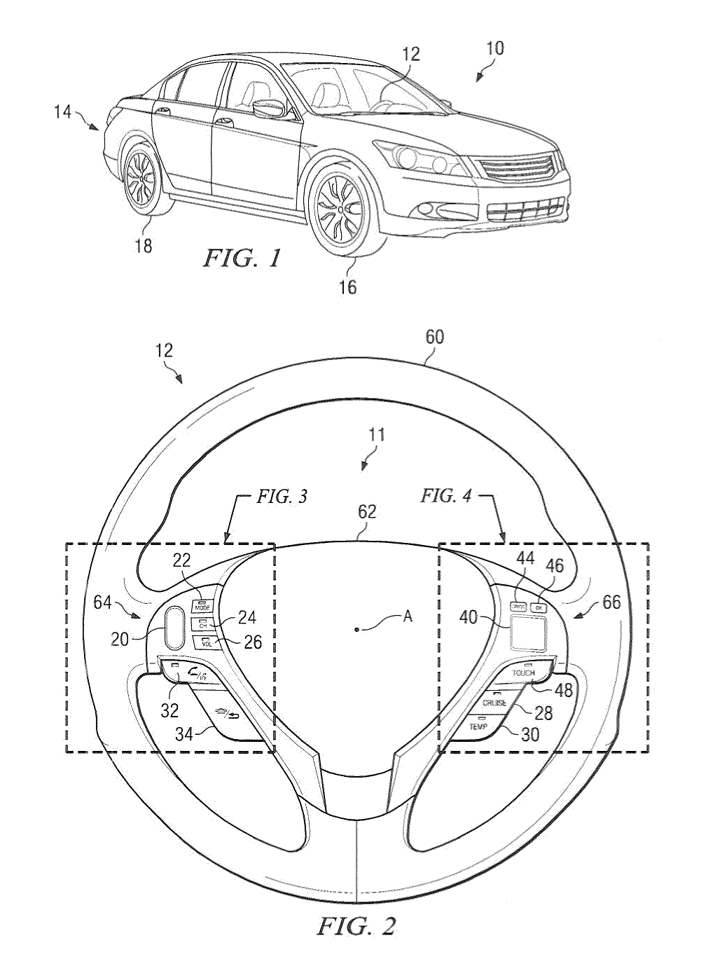

Referring to the drawings, FIG. 1 illustrates a vehicle 10 that can incorporate a steering wheel 12 according to one embodiment. The steering wheel 12 is shown partially in FIG. 1 and is illustrated further in FIGS. 2-4. Steering wheel 12 can be used in an automobile as shown in FIG. 1 and can be used in a variety of other vehicles including trucks, vans, and sport utility vehicles. In alternative embodiments, however, other steering control interfaces can be implemented on a vehicle. For example, a motorcycle can incorporate a set of handlebars. Vehicle 10 can include a frame (not shown), a body 14 supported by the frame, a pair of front wheels 16 (one shown) and a pair of rear wheels 18 (one shown). Wheels 16 and 18 can be suspended from the frame and are rotatable relative to the frame. The steering wheel 12 can be mechanically coupled to at least the front wheels 16 to permit an operator of vehicle 10 to steer vehicle 10. Vehicle 10 can further include an internal combustion engine (not shown) or any other suitable source of motive power, such as an electric motor.

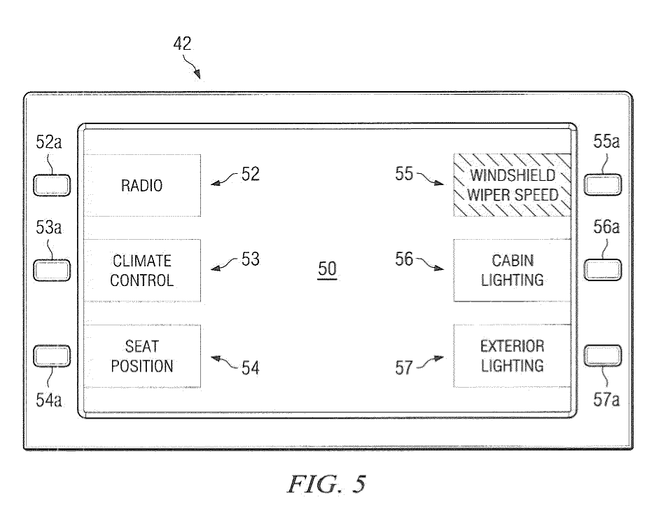

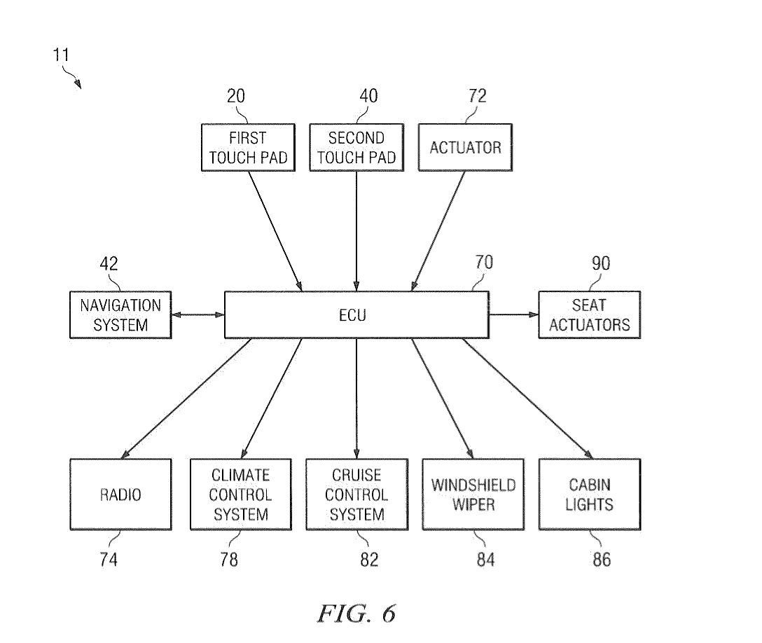

Vehicle 10 can be provided with a variety of features which facilitate effective and comfortable operation and use of the vehicle 10. For example, vehicle 10 can be provided with a climate control system, a cruise control system, a windshield wiper system, an interior lighting system, an exterior lighting system, an entertainment system (e.g., radio, CD player, cassette player, DVD player), and/or a seat positioning system. As is common, various functions (e.g., vehicular functions) of these features can be selectively controlled by an operator. In one embodiment, an operator can selectively increase or decrease certain vehicular functions such as, for example, radio volume, radio mode (e.g., AM/FM/CD), radio channel (e.g., radio presets), climate control temperature, climate control fan speed, cruise control speed, windshield wiper speed, cabin lighting intensity, and/or seat position. Vehicle 10 can also be provided with a navigation system (e.g., 42 in FIGS. 5 and 6). As is common, various functions of the navigation system can be selectively controlled by an operator of the vehicle 10.

As illustrated in FIG. 2, the steering wheel 12 can include a vehicular control system 11 that includes a first touch pad 20. The first touch pad 20 can be configured to receive an input from an operator to control certain vehicular functions. In one embodiment, the first touch pad 20 can be configured to increase and decrease a vehicular function according to an input from the operator. In such an embodiment, the operator can slide a finger upwardly along the first touch pad 20 to increase the vehicular function and can slide a finger downwardly along the first touch pad 20 to decrease the vehicular function. In one embodiment, the first touch pad 20 can comprise a capacitance sensing pad, but can, in alternative embodiments, comprise any of a variety of suitable alternative touch pads (e.g., conductance sensing pads).

The vehicular control system 11 can further include an actuator associated with the first touch pad 20. The actuator can be configured to facilitate selection from among a plurality of vehicular functions. In one embodiment, as illustrated in FIGS. 2-4, the actuator can comprise a plurality of pushbuttons, each pushbutton being associated with a particular vehicular function. In particular, the steering wheel 12 can include a Radio Mode pushbutton 22, a Radio Channel pushbutton 24, a Radio Volume pushbutton 26, a Cruise Control pushbutton 28, and a Climate Control Temperature pushbutton 30. In such an embodiment, the operator can select the vehicular function that is to be controlled by the first touch pad 20 by depressing the corresponding pushbutton. For example, the operator can depress the Radio Mode pushbutton 22 so that the operator can control the mode of the radio (e.g., AM, FM, Satellite Radio, CD) with first touch pad 20, can depress the Radio Channel pushbutton 24 so that the operator can control the radio channel with the first touch pad 20, can depress the Radio Volume pushbutton 26 so that the operator can control the radio volume with the first touch pad 20, can depress the Cruise Control pushbutton 28 so that the operator can control the set speed of the cruise control with the first touch pad 20, or can depress the Climate Control Temperature pushbutton 30 so that the operator can control the in-cabin temperature with the first touch pad 20. In one embodiment, when a Dual Climate Control function is activated on the climate control system (e.g., to permit the operator and passenger to personalize in-cabin climate settings) and the operator depresses the Climate Control Temperature pushbutton 30, the operator can control his/her personal in-cabin temperature with the first touch pad 20. The steering wheel 12 is additionally shown to include Cellular Phone Receive pushbutton 32 and Cellular Phone End pushbutton 34 which can be respectively selected by an operator to facilitate answering and termination of an incoming telephone call (e.g., the telephone can wirelessly interact with the vehicular control system 11 by way of BLUETOOTH® or some other suitable wireless protocol). In one embodiment, when an operator selects the Cellular Phone Receive pushbutton 32, the volume of the call can be controlled with the first touch pad 20. It will be appreciated that an actuator can be associated with any of a variety of other suitable vehicular functions that can be controlled by first touch pad 20.

During operation of the vehicle 10, different pushbuttons can be alternatively depressed to change the particular vehicular function currently controlled by the first touch pad 20. For example, when the vehicle 10 is equipped with a cruise control system, the operator can initially depress the Cruise Control pushbutton 28 to enable the operator to control the regulated speed of the vehicle 10 through use of the first touch pad 20. In particular, when the Cruise Control pushbutton 28 is depressed, the current speed of the vehicle is set as the cruise control speed which can be increased and/or decreased through use of the first touch pad 20. The The operator can then depress a different pushbutton (e.g., Radio Volume pushbutton 26), thereby enabling an operator to control a different vehicular function (e.g., radio volume) through use of the first touch pad 20.

In one embodiment, the vehicular control system 11 can incorporate automatic reversion whereby, when the operator changes the vehicular function being controlled by the first touch pad 20, the vehicular control system 11 can automatically switch back to the originally selected vehicular function after passage of a predetermined amount of time. For example, if the operator originally depresses the Cruise Control pushbutton 28 to facilitate use of the first touch pad 20 to control the cruise control system, and the operator subsequently changes the vehicular function by depressing the Radio Volume pushbutton 26, the first touch pad 20 can be used by the operator to adjust the radio volume for a predetermined amount of time (e.g., 30 seconds), after which period the vehicular control system 11 automatically switches the vehicular function such that the cruise control speed is again controllable through use of first touch pad 20. In one embodiment, the vehicular control system 11 can incorporate automatic reversion with respect to the Cruise Control pushbutton 28 such that any time the Cruise Control pushbutton 28 is depressed by an operator, a subsequently selected vehicular function will only be controllable by the first touch pad 20 for a predetermined amount of time following depression of a pushbutton corresponding with that selected vehicular function. It will be appreciated, however, that the vehicular control system 11 can incorporate automatic reversion in any of a variety of suitable alternative and/or additional manners. For example, automatic reversion can be incorporated with respect to alternative and/or additional vehicular functions. In another example, automatic reversion can be activated only when particular actuators are selected in a predefined sequence (e.g., upon depression of the Radio Channel pushbutton 24, followed by depression of the Cruise Control pushbutton 28).

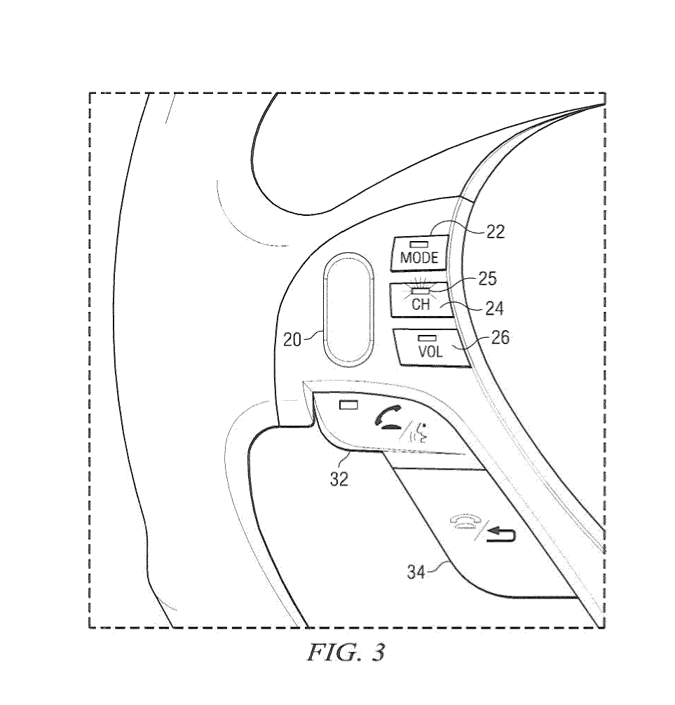

One or more of the pushbuttons can include an indication light (e.g., 25 in the case of the Radio Channel pushbutton 24, shown to be illuminated in FIG. 3) such that, when a vehicular function is selected, the indication light associated with the pushbutton for that vehicular function can be illuminated to inform the operator as to which of the vehicular functions is under present control of the first touch pad 20. For example, when the operator depresses a first pushbutton to control a vehicular function with the first touch pad 20, the indication light associated with the first pushbutton can be illuminated. When the operator depresses a second pushbutton to change the particular vehicular function presently controlled by the first touch pad 20, the indication light associated with the first pushbutton is deactivated and the indication light associated with the second pushbutton is illuminated. It will be appreciated that the indication lights can additionally or alternatively be illuminated automatically and without requiring depression of the pushbutton. For example and as described above, a vehicular control system 11 can automatically switch back to an originally selected vehicular function after passage of a predetermined amount of time from when an operator changes the vehicular function being controlled by the first touch pad 20. When the vehicular control system 11 automatically switches back to the originally selected vehicular function (e.g., from a radio volume control function to a cruise control function), the indicator light associated with the originally selected pushbutton can automatically illuminate to inform an operator that the originally selected vehicular function is under present control of the first touch pad 20.

It will be appreciated that, although the actuator is depicted in FIGS. 2-4 to include a plurality of pushbuttons, the actuator can include any of a variety of suitable alternative arrangements. For example, the actuator can comprise an individual pushbutton, whereby the operator can scroll through multiple vehicular functions by repeatedly depressing the pushbutton. In another example, the actuator can comprise a scroll wheel, whereby the operator can scroll through multiple vehicular functions by rotating the scroll wheel. It will also be appreciated that an actuator can have any of or variety of other configurations suitable to facilitate operator selection of a vehicular function.

As illustrated in FIG. 2, the vehicular control system 11 can further include a second touch pad 40 in electrical communication with the navigation system 42. The second touch pad 40 can be configured to receive an input from an operator to control certain functions of the navigation system 42. In one embodiment, the second touch pad 40 can be configured to navigate a cursor along a display screen of the navigation system 42 in response to an input from an operator. In such an embodiment, the operator can move a finger along the second touch pad 40 in any direction to cause a cursor displayed on a display screen to correspondingly move (e.g., similar to a mouse-cursor relationship in a personal computer). In another embodiment, the second touch pad 40 can be configured to select between a group of selectable menus provided on a display screen. In such an embodiment, the operator can slide a finger upwardly, downwardly, leftwardly, or rightwardly along the second touch pad 40 to effectively jump between menus in an upwardly, downwardly, leftwardly, or rightwardly direction, respectively. Similar to the first touch pad 20 described above, the second touch pad 40 can comprise a capacitance sensing pad or any of a variety of suitable alternative touch pads.

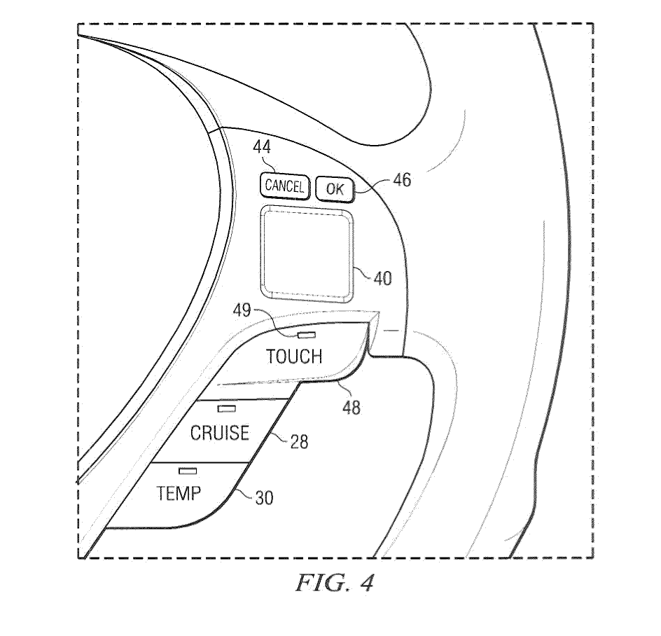

In one embodiment, as illustrated in FIGS. 2 and 4, the vehicular control system 11 can include a Cancel pushbutton 44, an OK pushbutton 46, and a Touch pushbutton 48, associated with the second touch pad 40. In such an embodiment, the operator can select the pushbuttons (44, 46, 48) to facilitate control of the navigation system 42. For example, the operator can select the Touch pushbutton 48 to selectively activate and deactivate the second touch pad 40. The Touch pushbutton 48 is shown to include an illumination light 49 which can illuminate when the second touch pad 40 is activated. The operator can then move a finger along the second touch pad 40 to indicate a desired location and/or menu on the display. Once the desired location and/or menu is located, the operator can select the OK pushbutton 46 to select the location and/or menu indicated at the location. The operator can select the Cancel pushbutton 44 to deactivate the second touch pad 40 and/or cancel a current function of the navigation system 42 (e.g., to deactivate the vehicle's cruise control). It will be appreciated that while FIGS. 2 and 4 depict pushbuttons, any of a variety of suitable alternative arrangements for facilitating control of a navigation system can be provided. For example, in one alternative embodiment, a vehicular control system might not include any Cancel pushbutton, OK pushbutton or Touch pushbutton, and tapping on the second touch pad by an operator can be recognized as a selection of a location or menu and the second touch pad might always be activated.

It will be appreciated that a destination can be entered into the navigation system 42 to generate driving directions. To facilitate entry of the destination, the navigation system 42 can provide a GUI-based keyboard. In one embodiment, the operator can highlight and select particular letters along the keyboard using the vehicular control system 11. For example, when the GUI-based keyboard is displayed by the navigation system 42, the operator can highlight different letters by sliding a finger along the second touch pad 40. Once a desired letter is highlighted, the operator can type the letter by selecting it (e.g., by selecting the OK pushbutton 46 or by double-tapping the second touch pad 40). If a particular letter is erroneously selected, the operator can depress the Cancel button to erase the previously selected letter. Once a desired destination has been typed, the operator can highlight and select an ‘enter’ button on the GUI-based keyboard.

It will be appreciated that the navigation system 42 can be configured to facilitate user-control of one or more vehicular control systems. In one embodiment, as illustrated in FIG. 5, the navigation system 42 can include a menu 50 that that facilitates selection of one of a plurality of vehicular control systems for user control. In particular, the menu 50 can display a radio control indicator 52, a climate control indicator 53, a seat position indicator 54, a windshield wiper speed control indicator 55, a cabin lighting indicator 56, and an exterior lighting indicator 57. A user can select one of the vehicular control systems by actuating one of a plurality of pushbuttons (e.g., 52a, 53a, 54a, 55a, 56a, 57a) associated with the indicators, or by touching the screen of the navigation system 42 (e.g., when the navigation system 42 is equipped with a touch responsive screen).

When the radio control indicator 52 is selected, the navigation system 42 can display a radio sub-menu that displays radio control variables such as volume control, tuner control, seek control, and/or channel control, for example. The operator can select particular radio control variables by sliding a finger along the second touch pad 40 to highlight a radio control variable and accordingly selecting the highlighted variable (e.g., by selecting the OK pushbutton 46 or by double-tapping the second touch pad 40). Once a particular radio control variable has been selected, the operator can slide a finger along the first touch pad 20 to increase or decrease the selected radio control variable. When the climate control indicator 53 is selected, the navigation system 42 can display a climate control sub-menu that displays climate control variables such as temperature control, fan speed control, and/or dual climate control, for example. The operator can select particular climate control variables by sliding a finger along the second touch pad 40 to highlight a climate control variable and accordingly selecting the highlighted variable (e.g., by selecting the OK pushbutton 46 or by double-tapping the second touch pad 40). Once a particular climate control variable has been selected, the operator can slide a finger along the first touch pad 20 to increase or decrease the selected climate control variable. When the seat position indicator 54 is selected, the navigation system 42 can display a seat positioning sub-menu that displays seat positioning control variables such as forward/aft control, seat tilt control, seatback control, and/or seat height control, for example. The operator can select particular seat position control variables by sliding a finger along the second touch pad 40 to highlight a seat position control variable and accordingly selecting the highlighted variable (e.g., by selecting the OK pushbutton 46 or by double-tapping the second touch pad 40). Once a particular seat position control variable has been selected, the operator can slide a finger along the first touch pad 20 to increase or decrease the selected seat position control variable. When the windshield wiper speed control indicator 55 is selected, as shown in FIG. 5, the operator can slide a finger along the first touch pad 20 to variably or incrementally increase or decrease the speed of the vehicle's windshield wipers. When the cabin lighting indicator 56 is selected, the operator can slide a finger along the first touch pad 20 to increase or decrease interior lighting (e.g., dome light, instrument cluster lighting, center console lighting, back lighting of interior control switches). When the exterior lighting indicator 57 is selected, the operator can slide a finger along the first touch pad 20 to select between exterior lighting modes (e.g., low beams, high beams, parking lights, daytime running lights, fog lights). It will be appreciated that the navigation system 42 can be configured to facilitate user-control of any of a variety of additional vehicular control systems. It will also be appreciated that increasing and decreasing buttons can alternatively or additionally be displayed by the navigation system 42 for each control variable.

Referring again to FIG. 2, the steering wheel 12 is shown to include a radial grip 60 and a center span 62 attached to the radial grip 60 such that the radial grip 60 is rotatably supported about a steering axis A. The center span 62 is shown to include a left support portion 64 and a right support portion 66 each radially extending between the axis A and the radial grip 60. The first touch pad 20, the second touch pad 40, and pushbuttons 22, 24, 26, 28, 30, 32, 34, 44, 46, 48 are shown to be disposed along the steering wheel 12 at locations that are reachable when an operator's hands are placed on the steering wheel 12 for steering of the vehicle. For example, the first touch pad 20, the Radio Mode pushbutton 22, the Radio Channel pushbutton 24, the Radio Volume pushbutton 26, the Cellular Phone Receive pushbutton 32, and the Cellular Phone End pushbutton 34 are each shown to be disposed along the left support portion 64 in order to facilitate interaction with an operator's left hand when the operator's left hand is grasping the steering wheel 12 adjacent to the left support portion 64. In addition, the second touch pad 40, the Cruise Control pushbutton 28, the Climate Control Temperature pushbutton 30, the Cancel pushbutton 44, the OK pushbutton 46, and the Touch pushbutton 48 are each shown to be disposed along the right support portion 66 in order to facilitate interaction with an operator's right hand when the operator's right hand is grasping the steering wheel 12 adjacent to the right support portion 66. It will be appreciated, however, that a steering control interface can be provided in any of a variety of suitable arrangements and that a first touch pad, a second touch pad, and an actuator can be provided along a steering control interface in any of a variety of suitable configurations. It will be appreciated that the first touch pad 20, the second touch pad 40, and the actuators can be coupled with the steering wheel 12 in any of a variety of suitable arrangements. For example, the first touch pad, second touch pad, and pushbuttons can be releasably secured (e.g., with screws) to the steering wheel 12.

The vehicular control system 11 can include an electronic control unit (ECU) 70, as shown in FIG. 6. The ECU 70 can be provided to control the engine of vehicle 10, as well as a variety of other components of vehicle 10. In one embodiment, as illustrated in FIG. 6, the ECU 70 can be in electrical communication with each of the first touch pad 20, the second touch pad 40, and the actuator 72 (e.g., pushbuttons 22, 24, 76, 28, 30). Each of the first touch pad 20, the second touch pad 40, and the actuator 72 can be configured to generate a respective signal based upon the operator's input. The ECU 70 can process these signals to control various vehicular functions such as of a radio 74, a climate control system 78, a cruise control system 82, a windshield wiper 84, cabin lights 86 and/or seat actuators 90. The ECU 70 can additionally process the signal from the second touch pad 40 to control the navigation system 42. In one embodiment, the ECU 70 can comprise a processor-based control, but can, in another embodiment, include any of a variety of suitable alternative control devices.

In one embodiment, the ECU 70 can be configured to facilitate automatic reversion as described above. In particular, the ECU 70 can be configured to operate in either a first mode or a second mode. When the ECU 70 is in the first mode, a first vehicular function is controlled by the signal generated from the first touch pad 20. When the ECU 70 is in the second mode, a second vehicular function is controlled by the signal generated from the first touch pad 20. The ECU 70 can switch between the first and second modes in response to a signal from the actuator 72 (e.g., one of the pushbuttons 22, 24, 26, 28, 30). The ECU 70 can be configured to switch operation from the first mode to the second mode and to maintain operation in the second mode for a predetermined amount of time. After the predetermined amount of time, the ECU 70 can automatically switch operation back to the first mode. For example, when an operator uses the actuator 72 to initially select a vehicular function to be controlled by the first touch pad 20, the ECU 70 operates in the first mode. When the operator subsequently uses the controller 72 to then change the vehicular function being controlled by the first touch pad 20, the ECU 70 can operate in the second mode for a predetermined amount of time. After the predetermined amount of time has elapsed, the ECU 70 returns to the first mode such that the initial vehicular function selected by the operator is again controlled by the first touch pad 20.

The ECU 70 is illustrated in FIG. 6 as a central processing unit for the vehicular control system 11. In particular, inputs from each of the first touch pad 20, the second touch pad 40, and actuator 72 are shown to be processed by the ECU 70 to control all vehicular functions associated with the ECU 70 (e.g., radio 74, climate control system 78, cruise control system 82, windshield wiper 84, cabin lights 86, and/or seat actuators 90). It will be appreciated, however, that a vehicular control system can be provided in any of a variety of suitable alternative arrangements which may or may not include an ECU, or in which an ECU may comprise a collection of components or systems distributed about a vehicle.

It will be appreciated that a vehicle equipped with the vehicular control system 11 can facilitate simple and convenient control of multiple features of the vehicle by an operator, and without requiring the operator to release the steering wheel to facilitate such control. For example, use of a bidirectional touch pad can facilitate selection of a desired magnitude of a vehicular function rather than incrementally raising or lowering the vehicular function (e.g., repeatedly actuating respective up and down keys) such as with conventional systems. In addition, by facilitating control of multiple such vehicular functions through use of a single bi-directional touch pad (e.g., first touch pad 20) it will be appreciated that this control capability can be achieved without requiring addition of substantial bulk to a steering interface. Moreover, since the second touch pad 40 facilitates the multi-directional control, the operator can quickly and easily select any menu provided on the navigation system display without the need to scroll serially through a list of menus.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto.

What is claimed is:

1. A vehicular control system comprising:
a steering control interface;
an actuator coupled with the steering control interface, the actuator being configured to facilitate selection from among a plurality of vehicular functions;
a first touch pad coupled with the steering control interface and configured to receive a first input from an operator, the first touch pad being further configured to facilitate control of a selected one of the vehicular functions according to the first input;
a navigation system; and
a second touch pad coupled with the steering control interface and configured to receive a second input from an operator, the second touch pad being further configured to facilitate control of the navigation system according to the second input.

2. The vehicular control system of claim 1 wherein the first touch pad is configured to facilitate increasing and decreasing of the selected one of the vehicular functions according to the first input.

3. The vehicular control system of claim 1 wherein the plurality of vehicular functions comprises at least one of a radio volume, a radio channel, a radio mode, a climate control temperature, a climate control fan speed, a cruise control speed, a windshield wiper speed, a seat position, an exterior lighting intensity, an incoming telephone call volume, and a cabin lighting intensity.

4. The vehicular control system of claim 1 wherein the second touch pad is configured to facilitate up, down, left, and right control of the navigation system.

5. The vehicular control system of claim 1 wherein the second touch pad is further configured to facilitate selection of an object displayed by the navigation system in response to tapping on the second touch pad by an operator.

6. The vehicular control system of claim 1 wherein the steering control interface comprises a radial grip and a center span attached to the radial grip and rotatably supporting the radial grip about a steering axis, the center span comprising a left support portion and a right support portion each radially extending between the steering axis and the radial grip.

7. The vehicular control system of claim 6 wherein the first touch pad is configured to interact with an operator's left hand when grasping the radial grip and the second touch pad is configured to interact with an operator's right hand when grasping the radial grip.

8. The vehicular control system of claim 1 wherein the actuator comprises at least one pushbutton.

9. The vehicular control system of claim 8 wherein the actuator comprises a plurality of pushbuttons.

10. The vehicular control system of claim 1 wherein the first touch pad is further configured to facilitate selective control of the navigation system according to the first input.

11. A vehicle including the vehicular control system of claim 1.

12. A vehicular control system comprising:
a steering control interface;
an actuator coupled with the steering control interface, the actuator being configured to facilitate selection by an operator from among a plurality of vehicular functions and being further configured to generate a first signal;
a touch pad coupled with the steering control interface and configured to receive an input from an operator, the touch pad being further configured to generate a second signal based upon the input; and
an electronic control unit in electrical communication with each of the actuator and the touch pad, the electronic control unit being configured to operate in either a first mode or a second mode wherein:
when the electronic control unit is in the first mode, the electronic control unit is configured such that a first one of the plurality of vehicular functions is controlled by the second signal;
when the electronic control unit is in the second mode, the electronic control unit is configured such that a second one of the plurality of vehicular functions is controlled by the second signal; and
upon generation of the first signal, the electronic control unit is configured to switch operation from the first mode to the second mode and to maintain operation in the second mode for a predetermined amount of time, after which predetermined amount of time the electronic control unit is configured to automatically switch operation back to the first mode.

13. The vehicular control system of claim 12 wherein, when the electronic control unit is in the first mode, the electronic control unit is configured such that the second signal facilitates increasing and decreasing of the first one of the plurality of vehicular functions.

14. The vehicular control system of claim 12 wherein the plurality of vehicular functions comprises at least one of a radio volume, a radio channel, a radio mode, a climate control temperature, a climate control fan speed, a cruise control speed, a windshield wiper speed, a seat position, an exterior lighting intensity, an incoming telephone call volume, and a cabin lighting intensity.

15. The vehicular control system of claim 12 wherein the steering control interface comprises a radial grip and a center span attached to the radial grip and rotatably supporting the radial grip about a steering axis, the center span comprising a left support portion and a right support portion each radially extending between the steering axis and the radial grip.

16. The vehicular control system of claim 15 wherein the touch pad is configured to interact with an operator's left hand when grasping the radial grip adjacent to the left support portion.

17. The vehicular control system of claim 12 wherein the actuator comprises at least one pushbutton.

18. The vehicular control system of claim 17 wherein the actuator comprises a plurality of pushbuttons.

19. A vehicle including the vehicular control system of claim 12.

20. A method of sequentially controlling respective vehicular functions through use of a touch pad, the method comprising:
receiving an operator input from a touch pad coupled with a steering control interface;
facilitating control of a first vehicular function from among a plurality of vehicular functions according to the operator input;
selecting a second vehicular function from among the plurality of vehicular functions;
for a predetermined amount of time following the selecting of the second vehicular function, facilitating control of the second vehicular function according to the operator input; and
upon completion of the predetermined amount of time, automatically resuming facilitating control of the first vehicular function according to the operator input.

21. The method of claim 20 wherein selecting a second vehicular function comprises receiving a signal from an actuator.
